(19) United States
(12) Patent Application Publication
(10) Pub. No.: US 2014/0199231 A1
(43) Pub. Date: Jul. 17, 2014

(54) SYSTEM, METHOD AND DEVICE FOR GENERATING CHLORINE DIOXIDE

(71) Applicant: Darrel George Wolf, Zeeland, ND (US)

(72) Inventor: Darrel George Wolf, Zeeland, ND (US)

(21) Appl. No.: 14/140,159

(22) Filed: Dec. 24, 2013

Related U.S. Application Data
(60) Provisional application No. 61/751,838, filed on Jan. 12, 2013.

(51) Int. Cl. C01B 11/02; B01J 8/02

(52) U.S. Cl. CPC C01B 11/024; B01J 8/02
USPC 423/477; 422/239

(57) ABSTRACT

A two-part system, method and device for producing a gaseous or aqueous chlorine dioxide solution is disclosed. The system includes a two part system where part one utilizes sodium chlorite in a dry chemical form (e.g., granulated, powder, and/or flake) securely contained within a device. Part two is a liquid acid solution that, when placed in contact with part one, will activate part one to produce chlorine dioxide gas or aqueous chlorine dioxide when water is added after part one is activated when exposed to part two which is a premade liquid acid solution.

### RELATED APPLICATIONS

This application claims the benefit of U.S. Provisional Application No. 61/751,838, titled “2 Part System and Device for Producing a Gas or an Aqueous Chlorine Dioxide” and filed on Jan. 12, 2013, which is incorporated herein by reference in its entirety.

### FIELD

The present invention relates generally to a generating chlorine dioxide, and, more particularly, to a system, method and device for point-of-use generation of chlorine dioxide with a two-part system. In accordance with the system, method, and device described herein, chlorine dioxide may be generated over a broad pH range, and may be made suitable for various uses.

### BACKGROUND

Chlorine dioxide is an effective antimicrobial agent at a concentration as low as 0.1 ppm and over a wide pH range. It is thought to penetrate cell walls and cell membranes and react with vital amino acids in the cytoplasm of the cell to kill the organism.

Unfortunately, chlorine dioxide is not stable during storage and can be explosive at high concentrations. As a result, chlorine dioxide gas is not produced and shipped under pressure. It is typically generated on-site using conventional chlorine dioxide generators or other means of generation. Conventional chlorine dioxide generation can be carried out in an efficient manner in connection with large-scale operations such as those in pulp and paper or water treatment facilities. In other applications, however, generating chlorine dioxide on-site may not be a good option. Conventional on-site chlorine dioxide generation can be costly, cumbersome and difficult because of the need for a generator and the need to handle the generator and the chemicals associated with the generation process.

There are many known methods for generating chlorine dioxide, including both chemical and electrolytic processes. In the chemical processes, chlorine dioxide is typically generated from oxidizing chlorite or reducing chlorate. These chemistries often result in very corrosive and sometimes unsafe disinfecting byproducts. Electrolytic processes typically generate chlorine gas to oxidize chlorite or generate a proton to reduce chlorates to chlorine dioxide. Although they achieve the desired end result of producing chlorine dioxide, these electrolytic cells can be very large in size and expensive. They may also contain fragile ion separation membranes, and may be too cumbersome for generating chlorine dioxide at the point of use. These prior art technologies can produce corrosive substances, have output product contaminated with impurities, be costly, or too slow in reaction rates for producing point-of-care products incorporating chlorine dioxide.

Some conventional systems may also use a membrane shell that water can absorb into with two compartments or two cavities, one having sodium chlorite and the other having granulated, acid. In these products they are separated until the water absorbs into the membrane and the water activate the acid them the acid absorbs through the wall that separates the two chemicals to activate the sodium chlorite. Although these products make chlorine dioxide they are very inefficient. The water doesn't dissolve the acid at a good rate of time so it is necessary use more acid then one should have to. By using more acid the mixture becomes more corrosive and more toxic and it isn't as efficient as it needs to be and it doesn't work as well compared to the disclosed inventive matter. It is important to appreciate that the more acid one uses the more dangerous the mixture becomes. Also, the amount of water and temperature of the water introduced into the reaction makes a difference on how the acid flows into the sodium chlorite chamber, the rate of production of chlorine dioxide, and the concentration of the resulting mixture. In general, the prior art devices and methods using two compartments are susceptible to premature activation by water, water vapor, or ambient humidity conditions and therefore are dangerous because they can become activated during storage and/or shipping and as a result have a reduced shelf life and pose a risk to transportation systems.

Dry compositions for generating chlorine dioxide solutions are known in the art. For example, U.S. Pat. No. 2,022,262, issued to White on Nov. 26, 1935, discloses stable stain-removing compositions made from a dry mixture of water-soluble alkaline chlorite salt, an oxalate and an acid. U.S. Pat. No. 2,071,091, issued to Taylor on Feb. 16, 1937, discloses the use of chlorous acid and chlorites to kill fungi and bacterial organisms by exposing the organisms to the compounds at a pH of less than about 7. The patent also discloses using dry mixtures of chlorites and acids to produce stable aqueous solutions useful as bleaching agents. U.S. Pat. No. 2,482,891, issued to Aston on Sep. 27, 1949, discloses stable, solid, substantially anhydrous compositions comprising alkaline chlorite salts and organic acid anhydrides which release chlorine dioxide when contacted with water.

Canadian Patent No. 959,238, issued to Callerame on Dec. 17, 1974, discloses using two water-soluble envelops, one containing sodium chlorite and one containing an acid, to generate chlorine dioxide. The envelopes are placed in water and the sodium chlorite and acid dissolve in the water and react to produce a chlorine dioxide solution. U.S. Pat. No. 2,071,094, issued to Vincent on Feb. 16, 1937, discloses deodorizing compositions in the form of dry briquettes formed of a mixture of soluble chlorite, an acidifying agent, and a filler of relatively low solubility. Chlorine dioxide is generated when the briquettes contact water.

U.S. Pat. No. 4,585,482, issued to Tice et al. on Apr. 29, 1986, discloses a long-acting biocidal composition comprising a microencapsulated mixture of chlorite and acid that when added to water releases chlorine dioxide. The primary purpose of the microencapsulation is to provide for hard particles that will be free flowing when handled. The microencapsulated composition also protects against water loss, from the interior of the microcapsule. The microcapsules produce chlorine dioxide when immersed in water. Unfortunately, the microcapsules release chlorine dioxide relatively slowly and are therefore not suitable for applications that require the preparation of chlorine dioxide on a relatively fast basis.

PCT Application PCT/US98/22564 (WO 99/24356), published on May 20, 1999, discloses a method and device for producing chlorine dioxide solutions wherein sodium chlorite and an acid are mixed and enclosed in a semi-permeable membrane device. When the device is placed in water, water penetrates the membrane. The acid and sodium chlorite dissolve in the water and react to produce chlorine dioxide. The chlorine dioxide exits the device through the membrane into the water in which the device is immersed producing a chlorine dioxide solution that can be used as an anti-microbial solution or for other purposes. The primary disadvantage of the disclosed device and method is that ambient moisture can penetrate the semi-permeable membrane and initiate the reaction prematurely.

In general, the prior art devices and methods using membranes are susceptible to premature activation by water or water vapor and therefore have a reduced shelf life unless sufficient steps are taken to protect the devices from exposure to ambient moisture or water. Such devices and methods are typically slow to interact with water and produce the desired chlorine dioxide. Also, in order to comply with U.S. Department of Transportation and other regulations, many prior art devices require that special and sometimes burdensome handling and shipping procedures be utilized in connection with the devices. For example, if sodium chlorite and acid are packaged together, certain restrictions may apply.

As a result, there is a need for a device for producing an gas and aqueous chlorine dioxide solution that has an extended shelf life compared to prior art devices, that is not susceptible to activation by ambient moisture, that forms a chlorine dioxide gas and solution much more quickly than prior art devices and that can be assembled and packaged in ways that avoid stringent handling and shipping regulations.

### SUMMARY

A two-part system and/or device for producing gaseous or aqueous chlorine dioxide is disclosed. The system includes a two-part system where part one that utilizes sodium chlorite (NaClO₂) in its dry chemical (granulated, powder, or flake) form securely contained within a device. To make a one compartment or a single cavity device can include sponges, tea bag-like containers or any other material including a container that has one compartment or one cavity and at least one side that could flow or absorb liquid through it and can hold sodium chlorite. The device can be made using a dissolvable material that creates one compartment or cavity that holds sodium chlorite that can then be placed into a container that would allow the user to add part two. Upon the addition of part two the material in part one is dissolved thereby activating the sodium chlorite to produce chlorine dioxide. The size of the single compartment cavity will depend on how much sodium chlorite is needed for the application. Part two is a liquid acid mixture that when placed in contact with part one will activate part one to produce chlorine dioxide (ClO₂) gas as well as a small amount of concentrated aqueous chlorine dioxide. If a lower concentration of aqueous chlorine dioxide is desired the user may add water to part one after part one has been activated with part two. Part two is a liquid acid mixture that may be premade to fully react with part one's formulation for the application so the resulting mixture produces is the desired acid liquid consistency to produce the desired concentration of chloride dioxide with the desired amount of part one. The acid formulation depends on how much chlorine dioxide is needed for the application and how fast the user requires it to generate the chlorine dioxide. Part two could be a wide range of acid solutions that will depend on the application. Some of the preferred embodiments calls for the use of either commercial or food grade sodium acid or sodium persulfate as well as either regular or food grade citric acid.

Some implementations can include an improved process of generating chlorine dioxide gas and aqueous solution for the purpose of microbial disinfection of meats, fruits, vegetables, and poultry, mold and allergy remediation, disinfectant and oxidizer with bleaching, deodorizing, bactericidal, viricidal, algaecidal, and fungicidal properties. Additionally the inventive matter disclosed is ideal for sanitizing air ducts and HVAC/R systems and animal containment areas (walls, floors, and other surfaces). The described matter is frequently used to control microorganisms on or around foods because it destroys the microorganisms without forming byproducts that pose a significant adverse risk to human health, e.g., chloramines and chlorinated organic compounds.

Some implementations can include a method for generating chlorine dioxide on-site, the method can include providing a first part including sodium chlorite in a powder form, and providing a second part including a liquid acid solution. The method can also include combining the second part and the first part so as to activate a reaction between the sodium chlorite and the acid solution to generate chlorine dioxide.

The method can further include adding water to the liquid acid solution so as to create an aqueous chlorine dioxide solution. The first part can be disposed in a container and the second part can be added to the container. The second part can be in a container and the first part can be added to the container.

The first part can be disposed in a liquid permeable pouch prior to combining with the second part. The first part can be in a loose form.

The method can also include adding a surfactant to the aqueous chlorine dioxide solution. The method can further include adding a citric concentrate to the aqueous chlorine dioxide solution.

Some implementations can include a system for generating chlorine dioxide on-site. The system can include a first part including sodium chlorite in a powder form. The system can also include a second part including a liquid acid solution, wherein the second part and the first part are configured to be combined so as to activate a reaction between the sodium chlorite and the acid solution to generate chlorine dioxide.

The system can also include water so as to create an aqueous chlorine dioxide solution. The first part can be disposed in a container and the second part is added to the container. The second part can be in a container and the first part can be added to the container. The first part is disposed in a liquid permeable pouch prior to combining with the second part.

The system can also include a surfactant. By using a surfactant, the chlorine dioxide solution can be made into a cleaner. The surfactant is for cleaning as a surfactant reduces the surface tension so that dirt can be more readily removed. There are many surfactant chemicals such as DOW Surfactants, including TRITON, DOWFAX, and TERGITOL, for example. The system can also include a citric concentrate.

Some implementations can include an apparatus for generating chlorine dioxide. The apparatus can include a first part including sodium chlorite in a powder form, and a second part including a liquid acid solution. The apparatus can also include a container having initially disposed therein one of the first part or the second part, wherein the second part and the first part are configured to be combined in the container by subsequently adding the other part so as to activate a reaction between the sodium chlorite and the acid solution to generate chlorine dioxide.

The apparatus can also include water to create an aqueous chlorine dioxide solution. The first part can be disposed in a container and the second part can be added to the container. The apparatus can also include one or more of a surfactant and a citric concentrate. The first part can be disposed in a liquid permeable pouch prior to combining with the second part.

### BRIEF DESCRIPTION OF THE DRAWINGS

FIG. 1 shows a diagram of an example device having a single compartment or cavity with sodium chlorite disposed therein in accordance with at least one embodiment.

FIG. 2 shows a diagram of an example device with one compartment or cavity having sodium chlorite disposed therein with part two (an acid) being poured into the device through the upper part of the compartment or cavity to create chloride dioxide in accordance with at least one embodiment.

FIG. 3 shows an example device in which part one is placed into a container or holder and then part two is poured into the container or holder in accordance with at least one embodiment.

FIG. 4 shows a diagram of an example system/process in which part one is placed into a container that already has part two disposed therein in accordance with at least one embodiment.

FIG. 5A shows a diagram of the container with the Part 2 therein in accordance with at least one embodiment.

FIG. 5B shows a diagram of an of the container with the Part 2 and Part 1 therein in accordance with at least one embodiment.

FIG. 6A shows an example process in which part one is activated in a container and water is then added to make an aqueous chlorine dioxide in accordance with at least one embodiment.

FIG. 6B shows an example process in which part one is activated in a container and water is then added as well as the top spray assembly to make an aqueous chlorine dioxide in accordance with at least one embodiment.

FIG. 7A shows a diagram of an example system/process in which part one is placed into a container in accordance with at least one embodiment.

FIG. 7B shows a diagram of an example system/process in which part one is placed into a container and then part two is poured into the container in accordance with at least one embodiment.

FIG. 7C shows a diagram of an example system/process in which part one is placed into a container and then part two is poured into the container and finally the water is added to fill the container in accordance with at least one embodiment.

FIG. 8A shows a diagram of an example device including a one compartment/one cavity device configured to hold sodium chlorite and through which the part two liquid can flow or absorb through and activate to make chlorine dioxide.

FIG. 8B shows a diagram of an example device after being folded over to contain the material including a one compartment/one cavity device configured to hold sodium chlorite and through which the part two liquid can flow or absorb through and activate to make chlorine dioxide.

### DETAILED DESCRIPTION

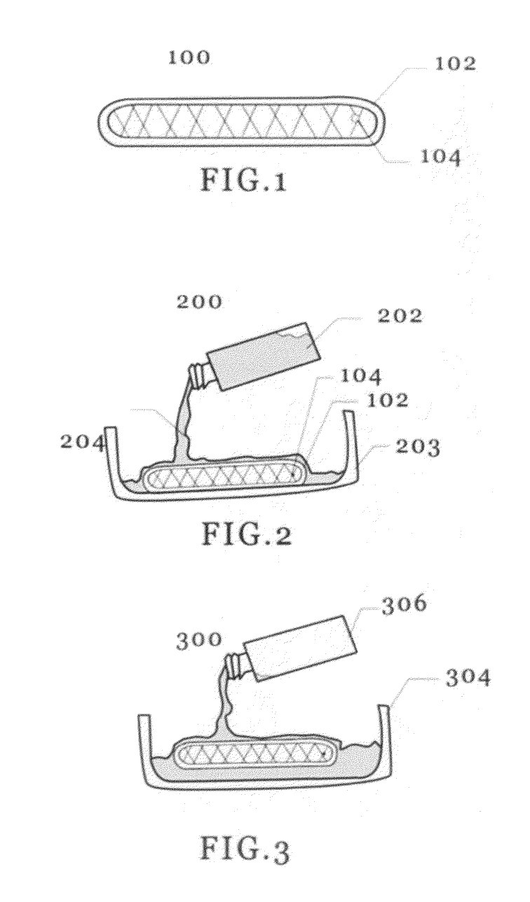

A two-part system, method and device for producing a gaseous or aqueous chlorine dioxide solution is disclosed. The system includes a two part system 302 and 306 of FIG. 3, where part one utilizes sodium chlorite in a dry chemical form 104 of FIG. 1 (e.g., granulated, powder and/or flake) securely contained within a permeable or semi permeable device, such as a tea bag or a sponge material, or even a dissolvable membrane 102 of FIG. 1. Part two 306 of FIG. 3 is a liquid acid solution that, when placed in contact with part one, will activate part one to produce chlorine dioxide gas. Additionally, aqueous chlorine dioxide can be produced when water is added to the solution after part one was activated upon exposure to part two, which is a premade liquid acid solution. Disclosed below are three examples of ways that part two can activate part one (sodium chlorite).

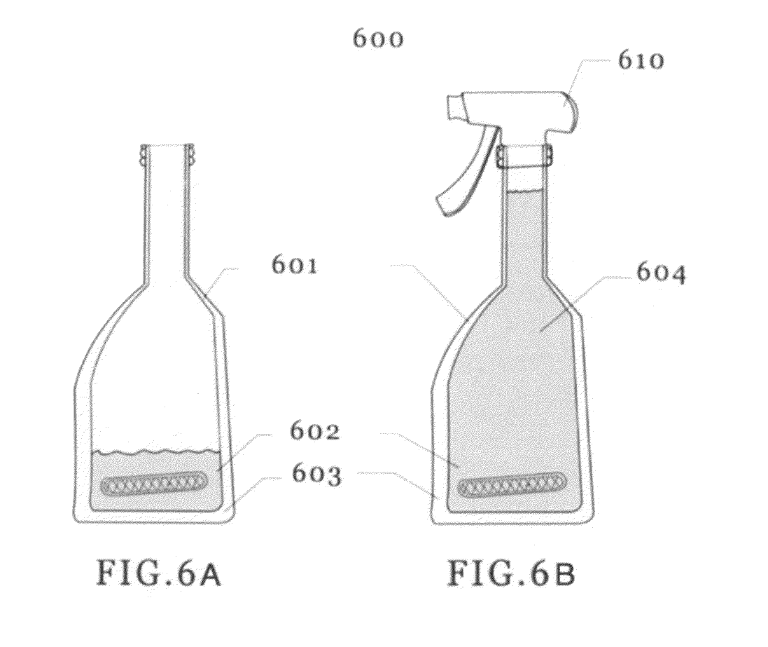

Example 1. The user can pour part two into a holder or container and then place the pouch containing part one into the holder or container and let the part two absorb or flow into the compartment of the pouch of part one to activate the sodium chlorite. As shown in FIGS. 5 and 6, and described below.

Example 2. Place the part one pouch into a holder or container and pour part two onto the part one pouch and have part two absorb or flow into the compartment to activate the sodium chlorite. As shown in FIGS. 2, 3 and 7, and described below.

Example 3. Put the loose sodium chlorite that may be accomplished by cutting open the pouch of part one and pouring part one into a container or holder and then pour part 2 onto the sodium chlorite to activate it.

Part 2 is introduced into the compartment, container or holder where the sodium chlorite is held such that the chemical(s) in the compartment will meet with the sodium chlorite to produce a chlorine dioxide gas or provide for an aqueous solution (e.g., if water is added to the compartment, pouch, or container after activating the sodium chlorite to make an aqueous chlorine dioxide). The solution can then be used as a disinfectant, decontamination and/or deodorizing solution. Additionally, surfactants may be added to produce a cleaning solution as well.

FIG. 1 shows a diagram of an example device 100 having a single permeable or dissolvable compartment or cavity 102 with sodium chlorite 104 disposed therein. The permeable or dissolvable compartment or cavity 102 may be in the form of a permeable sponge like material as well as the material commonly found in tea bags as well as a dissolvable organic material.

FIG. 2 shows a diagram of an example device 200 with a single compartment or cavity 102 having sodium chlorite 104 disposed therein with part two (an acid) 202 being poured into the device 204 of the compartment or cavity 203 to create chloride dioxide when the two materials are mixed.

FIG. 3 shows an example device 300 in which part one 302 is placed into a container or holder 304 and then part two 306 is poured into the container or holder 304. Alternatively, part two 306 can be poured into the container 304 first and then part one 302 can be added to the container 304.

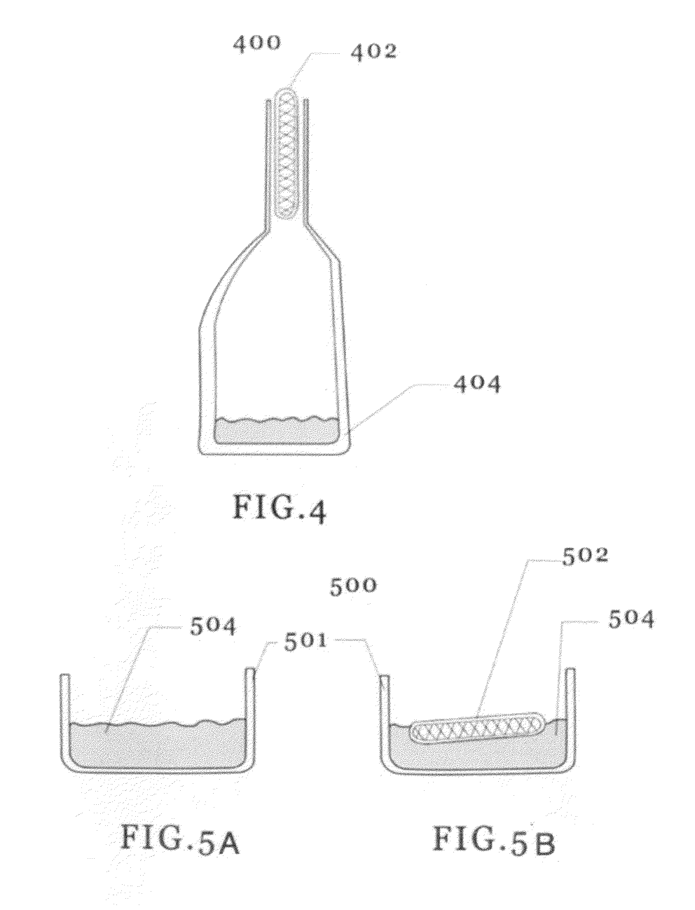

FIG. 4 shows a diagram of an example system/process 400 in which part one 402 is placed into a container that already has part two 404 disposed therein. After part one is activated, water can be added to make an aqueous chloride dioxide solution for the purpose of making a mixture suitable for spraying on the desired surface, such as vegetables, or on a dog that was sprayed with a skunk for the purposes of quickly and efficiently removing the skunk odor from the dog.

FIG. 5 shows a diagram of an example process 500 for making chlorine dioxide in which part two 504 is poured into the container or holder first and then part one 502 is placed into the container.

FIG. 6A shows an example process 600 in which part one 602 is activated with part 2 603 in a container 601 and FIG. 6B shows the water 604 is then added to make an aqueous chlorine dioxide solution. The spray head 610 is shown on this drawing to show how the aqueous chlorine dioxide solution may be contained to provide a means to spray the mixture on the desired surface.

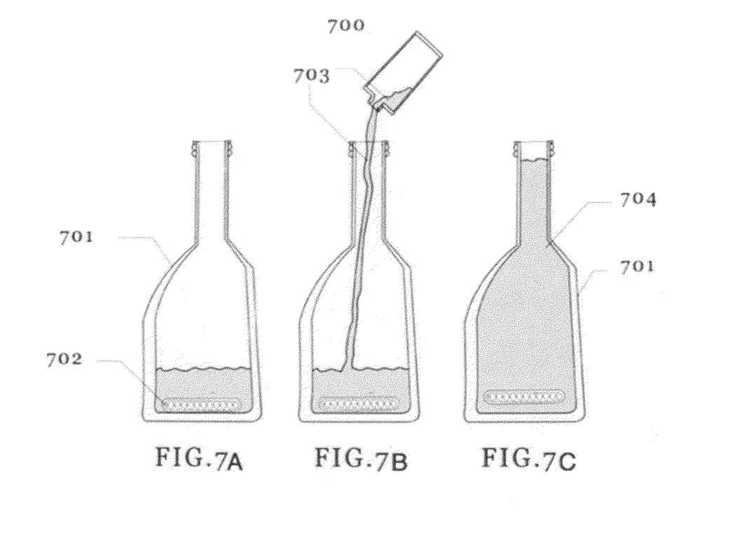

FIG. 7A shows a diagram of an example system/process 700 in which part one 702 is placed into a container 701. FIG. 7B shows part two 703 is poured into the container 701 in accordance with at least one embodiment. In FIG. 7C, after part one 702 is activated, water 704 can be added to the container 701 to make an aqueous chloride dioxide solution.

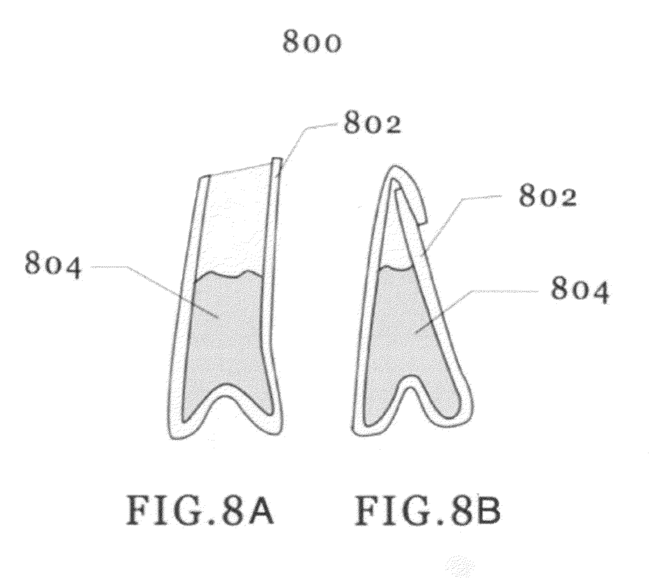

FIG. 8A AND FIG. 8B shows a diagram of an example device including a single compartment or one cavity device 802 wherein the sodium chlorite 804 is added to the compartment configured to hold sodium chlorite and through which the part two liquid can flow or absorb through and activate to produce chlorine dioxide much like a tea bag.

In order to avoid the difficulty of using conventional chlorine dioxide generators, the expense associated with handling and shipping stabilized chlorine dioxide solutions and related precursor solutions and the dangers associated with activating chlorine dioxide solutions, dry compositions containing chemicals (e.g., sodium chlorite) that react with acid solution to form chlorine dioxide. The compositions can be easily shipped to remote locations in dry form (e.g. sodium chlorite). The necessary acid solution can be merely added on site. For example, in an application wherein a disinfectant solution is needed to clean surfaces, a dry composition containing a metal chlorite and an acid solution can be mixed on site and add water which causes the components to react and produce an aqueous chlorine dioxide solution. The solution is then used to disinfect the surfaces. The aqueous chlorine dioxide solution is produced when chlorite anion is converted to chlorine dioxide.

In accordance with some implementations, a device for producing a gas or aqueous chlorine dioxide when exposed to acid solution is provided. The device comprises a pouch defining a one compartment or one cavity, which includes one dry chemical (sodium chlorite) components capable of producing chlorine dioxide gas or aqueous chlorine dioxide when exposed acid mixture solution. When the acid mixture solution goes into the device and get in contact with the compartment with sodium chlorite whereby when the device is exposed to the acid mixture solution the chemical component(s) dissolve the sodium chlorite to produce chlorine dioxide gas in the compartment, and chlorine dioxide gas exits the compartment through the device.

In a preferred embodiment, the compartment of the device includes a sodium chlorite. In use, for example, the device is submersed in a container acid mixture solution. This means quickly absorbs of acid mixture solution into the compartment. The acid mixture solution goes in the compartment then dissolves the sodium chlorite and reacts to produce chlorine dioxide gas in the compartment. The chlorine dioxide gas passes through the device. To make an aqueous solution add water to the device or container if necessary transfer the device to a bigger container and add water. The solution can be used, for example, to disinfect surfaces, deodorize, mold remediation, Decontaminate surfaces, topical skin or biological product surface disinfecting, and a spray for fruit and vegetables.

Important advantages of the inventive device are that it can be modified to meet applicable shipping and handling regulations. For example, in part one embodiment, the device is packaged to include only the pouch and in the compartment of the pouch only includes sodium chlorite of the device and part one is in a sealed foil bag. The acid solution is separately packaged with the device. By packaging the acid mixture solution separately, it will prevent the chemicals to react. As a result, less stringent regulations regarding the shipping and handling. By using a one compartment or one cavity pouch and an acid mixture solution. (Part one and part two can be modified to speed up the release of the chloride dioxide and increase or decrease the amount of chloride dioxide depending on the application.)

If necessary or desirable for the end-use application, a weight can be attached or put into pouch (placed into the compartment) or otherwise incorporated into the device to ensure that the device is immersed when it is placed in a body of water. And you can also add a surfactant or citric considerate to create a cleaner/degreaser.

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the claims. All references cited are incorporated by reference in their entirety. Although the foregoing invention has been described in detail for purposes of clarity of understanding, it is contemplated that certain modifications may be practiced within the scope of the appended claims.

What is claimed is:

1. A method for generating chlorine dioxide on-site, the method comprising:
providing a first part including sodium chlorite in a powder form;
providing a second part including a liquid acid solution; and
combining the second part and the first part so as to activate a reaction between the sodium chlorite and the acid solution to generate chlorine dioxide.

2. The method of claim 1, further comprising adding water to the liquid acid solution so as to create an aqueous chlorine dioxide solution.

3. The method of claim 1, wherein the first part is disposed in a container and the second part is added to the container.

4. The method of claim 1, wherein the second part is in a container and the first part is added to the container.

5. The method of claim 1, wherein the first part is disposed in a liquid permeable pouch prior to combining with the second part.

6. The method of claim 1, wherein the first part is in a loose form.

7. The method of claim 2, further comprising adding a surfactant to the aqueous chlorine dioxide solution.

8. The method of claim 2, further comprising adding a citric concentrate to the aqueous chlorine dioxide solution.

9. A system for generating chlorine dioxide on-site, the system comprising:
a first part including sodium chlorite in a powder form; and
a second part including a liquid acid solution, wherein the second part and the first part are configured to be combined so as to activate a reaction between the sodium chlorite and the acid solution to generate chlorine dioxide.

10. The system of claim 9, further comprising water so as to create an aqueous chlorine dioxide solution.

11. The system of claim 9, wherein the first part is disposed in a container and the second part is added to the container.

12. The system of claim 9, wherein the second part is in a container and the first part is added to the container.

13. The system of claim 9, wherein the first part is disposed in a liquid permeable pouch prior to combining with the second part.

14. The system of claim 10, further comprising a surfactant.

15. The system of claim 10, further comprising a citric concentrate.

16. An apparatus for generating chlorine dioxide, the apparatus comprising:
a first part including sodium chlorite in a powder form;
a second part including a liquid acid solution;
a container having initially disposed therein one of the first part or the second part, wherein the second part and the first part are configured to be combined in the container by subsequently adding the other part so as to activate a reaction between the sodium chlorite and the acid solution to generate chlorine dioxide.

17. The apparatus of claim 16, further comprising water to create an aqueous chlorine dioxide solution.

18. The apparatus of claim 16, wherein the first part is disposed in a container and the second part is added to the container.

19. The apparatus of claim 16, further comprising one or more of a surfactant and a citric concentrate.

20. The apparatus of claim 16, wherein the first part is disposed in a liquid permeable pouch prior to combining with the second part.
